(19) United States
(12) Patent Application Publication
(10) Pub. No.: US 2024/0016278 A1
(43) Pub. Date: Jan. 18, 2024

(54) ASSEMBLY AND FRAGRANCE PRODUCT

(71) Applicant: DAIKIN INDUSTRIES, LTD., Osaka (JP)

(72) Inventors: Yuuki Kuwajima, Osaka (JP); Takeshi Kozuki, Osaka (JP); Hiroaki Wada, Osaka (JP); Kenjiro Tanimoto, Osaka (JP)

(73) Assignee: DAIKIN INDUSTRIES, LTD., Osaka (JP)

(21) Appl. No.: 18/470,607

(22) Filed: Sep. 20, 2023

Related U.S. Application Data
(63) Continuation of application No. PCT/JP2022/012812, filed on Mar. 18, 2022.

(30) Foreign Application Priority Data
Mar. 22, 2021 (JP) 2021-047829

(51) Int. Cl. A45D 34/02

(52) U.S. Cl. CPC A45D 34/02; A45D 2200/053; A45D 2200/057

(57) ABSTRACT

An assembly includes a tube that transfers a liquid having a refractive index of 1.35 to 1.41, and a formed article provided with a fitting section to which one end of the tube is fitted. The formed article is formed from a non-fluoropolymer. The tube is formed from a fluoropolymer having a tensile elastic modulus of 300 MPa or more. The non-fluoropolymer has a tensile elastic modulus that is not less than 1.2 times the tensile elastic modulus of the fluoropolymer.

### TECHNICAL FIELD

The present disclosure relates to an assembly in which a tube is fixed to a formed article, and the assembly can be used as, for example, an assembly that is attached to the opening of a container and injects a liquid in the container. The present disclosure also relates to a fragrance product that can be used for injecting a liquid fragrance.

### BACKGROUND

Spray pumps and dispenser pumps are used for injecting liquid fragrances. For example, Patent Document 1 discloses a fragrance product equipped with a container and a dispenser assembly. In the fragrance product described in Patent Document 1, the dispenser assembly is equipped with a transport assembly including a pump that transports a liquid fragrance from the inside of the container to the outside for application to an individual, and a tube that is connected to the transport assembly and extends into the liquid fragrance.

### PATENT DOCUMENT

Patent Document 1: Japanese Patent Laid-Open No. 2014-12185

### SUMMARY

The present disclosure provides an assembly that can easily fix a tube to a formed article.

According to the present disclosure, provided is an assembly comprising a tube that transfers a liquid having a refractive index of 1.35 to 1.41, and a formed article provided with a fitting section to which one end of the tube is fitted, wherein the formed article is formed from a non-fluoropolymer, and the tube is formed from a fluoropolymer having a tensile elastic modulus of 300 MPa or more, and the non-fluoropolymer has a tensile elastic modulus that is not less than 1.2 times the tensile elastic modulus of the fluoropolymer.

It is preferable that the assembly of the present disclosure further comprises an injection apparatus that injects a liquid having a refractive index of 1.35 to 1.41, wherein the injection apparatus comprises the formed article as a holding member provided with a fitting section to which one end of the tube is fitted.

It is preferable that the fluoropolymer has a refractive index of 1.35 to 1.41.

It is preferable that the fluoropolymer has a haze value of 30% or lower.

It is preferable that the fluoropolymer has a light transmittance at a wavelength of 400 nm of 50% or higher.

It is preferable that the tube is formed from at least one fluoropolymer selected from the group consisting of a copolymer containing ethylene unit and tetrafluoroethylene unit, and a polymer containing vinylidene fluoride unit.

It is preferable that the tube is formed from two or more fluoropolymers having different monomer compositional features.

It is preferable that the tube is insoluble in acetone.

It is preferable that the formed article is formed from at least one non-fluoropolymer selected from the group consisting of a polyolefin and a polyester.

It is preferable that the inner circumferential surface of the fitting section of the formed article is provided with unevenness.

It is preferable that the inner diameter of the fitting section of the formed article is smaller than the outer diameter of the tube by 0.5% or more.

It is preferable that a cut-out is provided at at least the one end of the tube.

According to the present disclosure, also provided is a fragrance product comprising the assembly as described above and a container body.

According to the present disclosure, there can be provided an assembly that can easily fix a tube to a formed article.

### BRIEF DESCRIPTION OF THE DRAWINGS

FIG. 1 is a schematic diagram showing one or more embodiments of a spray container that is equipped with an assembly.

FIG. 2 is a schematic cross-sectional view showing one or more embodiments of a connection structure between a holding member (formed article) of an injection apparatus and a tube.

FIG. 3 is a schematic diagram showing one or more embodiments of a tube.

FIGS. 4A-4J are images showing the results of immersion test of tube in liquid fragrance (invisibility) of Comparative Examples 1-3 and Examples 1-7.

FIGS. 5A-5J are images showing the results of immersion test of tube in liquid fragrance (invisibility) of Examples 8-17.

### DETAILED DESCRIPTION

Hereinafter, one or more embodiments in the present disclosure will be described in detail, but the present disclosure is not any more limited to the following embodiments.

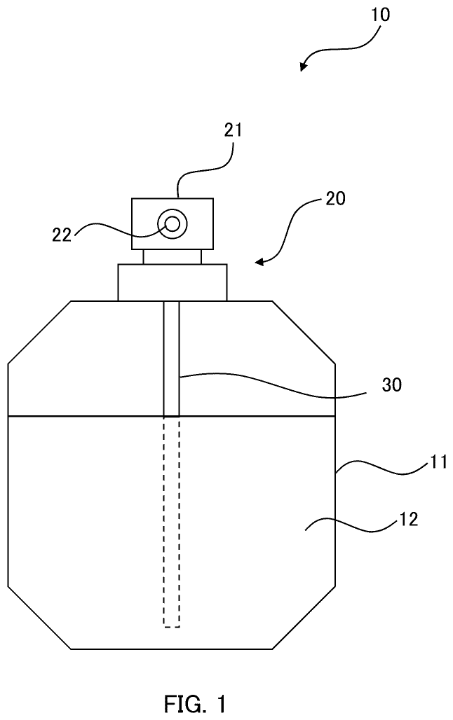

FIG. 1 shows one or more embodiments of a spray container that can manually inject a predetermined amount of a liquid each time. A spray container 10 shown in FIG. 1 is equipped with a container body 11, an assembly equipped with an injection apparatus 20 and a tube 30, and a liquid 12 accommodated in the container body 11. The injection apparatus 20 is attached so as to seal the container body 11. The injection apparatus 20 is provided with an injection pump, and by pressing down an injection button 21, the liquid 12 sucked up through the tube 30 is injected from an injection port 22.

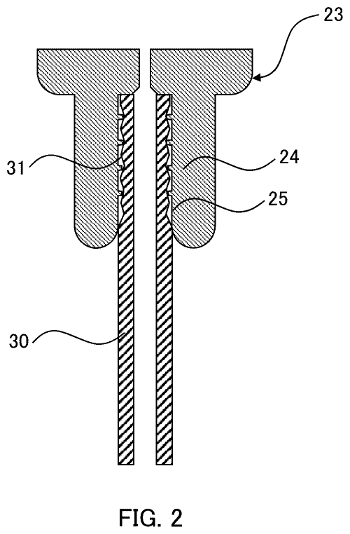

FIG. 2 is a schematic cross-sectional view showing one or more embodiments of a connection structure between an injection apparatus and a tube in a spray container. As shown in FIG. 2, the injection apparatus 20 is equipped with a holding member 23, which is directly or indirectly linked to an injection pump, and the holding member 23 is constituted by a formed article formed from a non-fluoropolymer. The holding member 23 is also provided with a fitting section 24, to which one end of the tube 30 is fitted.

Patent Document 1 discloses a dispenser assembly equipped with a tube that is connected to a transport assembly and extends into a liquid fragrance. However, in this conventional configuration, it is difficult to mount the tube for supplying the liquid fragrance to the transport assembly. Accordingly, an assembly that can easily fix a tube to an injection apparatus is desired.

In the connection structure shown in FIG. 2, one end of the tube is fitted to the fitting section 24 of the holding member 23. The non-fluoropolymer of the formed article that constitutes the holding member 23 has a tensile elastic modulus that is not less than 1.2 times the tensile elastic modulus of a fluoropolymer of the tube 30, and since the tensile elastic modulus of the fluoropolymer is 300 MPa or more, the tube 30 is not bent when inserting one end of the tube 30 into the fitting section 24 of the holding member 23. Furthermore, when one end of the tube 30 is inserted into the fitting section 24 of the holding member 23, the one end of the tube 30 is elastically deformed and an outer circumferential surface 31 of the tube 30 is thus pressed against an inner circumferential surface 25 of the fitting section 24 of the holding member 23. According to the assembly of the present disclosure, the tube 30 can be easily fixed to the injection apparatus 20 in the manner described above.

The holding member 23 of the injection apparatus 20 is constituted by a formed article formed from a non-fluoropolymer. The non-fluoropolymer is not limited as long as it exhibits a tensile elastic modulus of a multiplying factor within the range described above relative to the tensile elastic modulus of a fluoropolymer of the tube 30, but at least one selected from the group consisting of a polyolefin and a polyester is preferred, at least one selected from the group consisting of polypropylene, polyethylene, and polyethylene terephthalate is more preferred, and polypropylene is still more preferred.

The tensile elastic modulus of the non-fluoropolymer forming the holding member 23 of the injection apparatus 20 may be not less than 1.2 times the tensile elastic modulus of a fluoropolymer of the tube 30, not less than 1.3 times, as the insertion of the tube 30 into the fitting section 24 is made even easier, not less than 1.5 times, not less than 1.7 times, or not less than 2.0 times.

From the viewpoint of allowing the holding member 23 of the injection apparatus 20 to have sufficient strength, the tensile elastic modulus of the non-fluoropolymer forming the holding member 23 of the injection apparatus 20 is of a multiplying factor within the range described above relative to the tensile elastic modulus of a fluoropolymer of the tube 30, and it may also be 360 MPa or more, 600 MPa or more, 800 MPa or more, or 1,000 MPa or more, and may be 2,000 MPa or less, or 1,500 MPa or less.

The tube 30 is formed from a fluoropolymer. By setting the tensile elastic modulus of the fluoropolymer forming the tube 30 to 300 MPa or more, the tube 30 can be easily inserted into the fitting section 24 of the holding member 23 formed from the non-fluoropolymer described above. As the insertion of the tube 30 is made even easier, the tensile elastic modulus of the fluoropolymer forming the tube 30 may be 350 MPa or more, 400 MPa or more, 450 MPa or more, 500 MPa or more, or 550 MPa or more, and may be 1,000 MPa or less, 800 MPa or less, or 750 MPa or less.

The tensile elastic modulus of the non-fluoropolymer and the fluoropolymer can be specified by the following method. Pellets of these polymers are charged in a metal mold, set on a press machine heated at 200 to 300° C., and melt pressed at a pressure of 3 MPa to thereby obtain a sheet of 2 mm in thickness of the non-fluoropolymer and the fluoropolymer, respectively. Then, by using the respective obtained sheets, the tensile elastic modulus is measured according to ASTM D638 under the condition of 25° C. and 50 mm/min.

The inner circumferential surface 25 of the fitting section 24 of the holding member 23 is provided with unevenness, which further increases the pressure contact force between the outer circumferential surface 31 of the tube 30 and the inner circumferential surface of the fitting section 24 of the holding member 23, and enables the tube 30 to be fixed more firmly to the injection apparatus 20. In FIG. 2, a plurality of annular convex sections is provided on the inner circumferential surface 25 of the fitting section 24 of the holding member 23, but the shape of the unevenness is not limited to this. The height from the bottom point of the concave section to the apex of the convex section in the shape of the unevenness may be 0.005 mm or more, 0.01 mm or more, or 0.02 mm or more. It is also preferable for the height from the bottom point of the concave section to the apex of the convex section in the shape of the unevenness to be equal to or less than half of the thickness of the tube 30. When the height of the convex section is too small, the increase in pressure contact force may be insufficient, and when it is too large, bending of the tube 30 may occur at the time of insertion.

The outer circumferential surface 31 of one end of the tube 30 is provided with unevenness, which further increases the pressure contact force between the outer circumferential surface 31 of the tube 30 and the inner circumferential surface 25 of the fitting section 24 of the holding member 23, and enables the tube 30 to be fixed more firmly to the injection apparatus 20. In FIG. 2, a plurality of annular convex sections is provided on the outer circumferential surface 31 of one end of the tube 30, but the shape of the unevenness is not limited to this.

In one or more embodiments of the connection structure, only one of the inner circumferential surface 25 of the fitting section 24 of the holding member 23 and the outer circumferential surface 31 of one end of the tube 30 can be provided with unevenness, which further increases the pressure contact force between the outer circumferential surface 31 of the tube 30 and the inner circumferential surface 25 of the fitting section 24 of the holding member 23. Alternatively, unevenness can be provided on both the outer circumferential surface 31 of the tube 30 and the inner circumferential surface 25 of the fitting section 24 of the holding member 23. It is preferable to provide unevenness only on the side of the holding member 23, which has a higher tensile elastic modulus. This not only improves the insertability of the tube, but also increases the pressure contact between the tube and the holding member, which enables the tube 30 to be fixed more firmly to the injection apparatus 20. In one or more embodiments of the connection structure, as shown in FIG. 2, the inner circumferential surface 25 of the fitting section 24 of the holding member 23 can be provided with unevenness, and the tube 30 can be fixed to the injection apparatus 20 by the pressure contact force and engagement of the unevenness between the two formed after the insertion.

It is preferable to configure the inner diameter of the fitting section 24 of the holding member 23 so that it is smaller than the outer diameter of the tube 30 by 0.5% or more. By making the inner diameter of the fitting section 24 of the holding member 23 sufficiently smaller than the outer diameter of the tube 30, the pressure contact force between the outer circumferential surface 31 of the tube 30 and the inner circumferential surface 25 of the fitting section 24 of the holding member 23 is further increased, and the tube 30 can be fixed more firmly to the injection apparatus 20.

After insertion into the holding member 23, the tube 30 may be held by the holding member 23 with a force of 3 N or more, held with a force of 5 N or more, held with a force of 8 N or more, or held with a force of 11 N or more, and may be held with a force of 25 N or less. When the force with which the tube is held is too small, it may fall out at the time of use, and when the force is too large, the tube may buckle at the time of insertion.

The force with which the tube is held can be specified by measuring the maximum value of the holding force at room temperature when the tube held by the holding member is removed from the holding member using the Digital Force Gauge FGP series (FGP-5) manufactured by Nidec-Shimpo Corporation and a jig to sandwich the tube.

The outer diameter of the tube 30 is not limited, but may be 0.5 to 5.0 mm, 1.0 to 3.0 mm, 1.2 to 2.0 mm, may be 1.4 to 1.8 mm. The thickness of the tube 30 is not limited either, but may be 0.05 to 0.8 mm, 0.1 to 0.6 mm, or 0.3 to 0.5 mm.

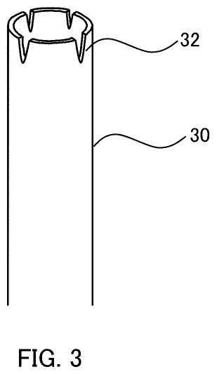

As shown in FIG. 3, the tube 30 can be provided with a cut-out 32 at one end, and this cut-out 32 allows the tube 30 to be elastically deformed more easily when the one end of the tube 30 is inserted into the fitting section 24 of the holding member 23, making the insertion of the tube 30 into the fitting section 24 of the holding member 23 even easier and making it possible to further suppress bending of the tube 30 at the time of insertion. The number and position of cut-outs are not limited. For example, two pairs of cut-outs may be provided so that they are perpendicular to each other, as shown in FIG. 3. Alternatively, a pair of cut-outs may be provided so that they face each other. The depth of the cut-out may be 0.1 mm or more, or 0.2 mm or more, and may be 3 mm or less. When the depth is too shallow, the effect of suppressing bending may become small, and when the depth is too deep, the holding force may be decreased.

The tube 30 may be provided with a cut-out only at one end and the one end provided with the cut-out may be inserted into the fitting section 24 of the holding member 23, but the tube 30 may be provided with a cut-out not only at one end but also at the other end since the tube can be produced omitting the step of checking the insertion direction.

It is preferable for the container body 11 to be sufficiently transparent to the extent that the liquid 12 accommodated inside can be seen. The liquid 12 accommodated in the transparent container has a refractive index of 1.35 to 1.41. Examples of such a liquid include a liquid fragrance. The liquid fragrances are liquids containing components diffusing aroma, and usually contain perfume components. The liquid fragrances are constituted, for example, by suitably blending perfume components constituting base notes, perfume components constituting middle notes and perfume components constituting top notes. The liquid fragrances are classified, depending on content proportions of the perfume components, for example, into perfume extracts, perfumes, eau de toilette, eau de cologne, aftershaves. Here, the refractive index can be measured at 25° C. by using an Abbe's refractometer with the sodium D-line as the light source.

Next, the tube 30 will be described in more detail. The present disclosure also relates to a tube, and the tube of the present disclosure is one that can be easily fixed to a fitting section of a formed article formed from a non-fluoropolymer.

As described above, the container body 11 of the spray container 10 shown in FIG. 1 accommodates the liquid 12 having a refractive index of 1.35 to 1.41, and part of the tube 30 extending from the holding member 23 of the injection apparatus 20 is immersed in the liquid 12. The liquid 12 in the container body 11 is sucked up through the tube 30 to the injection apparatus 20, where it is injected from the injection port 22 of the injection apparatus 20.

The tube 30 is formed from a fluoropolymer having a tensile elastic modulus of 300 MPa or more, which enables the tube 30 to be easily inserted into the fitting section 24 of the holding member 23, and also imparts durability against the liquid 12 and some degree of transparency to the tube 30.

Liquid fragrances as one example of liquids having a refractive index of 1.35 to 1.41 are often sold in the form of being accommodated in transparent containers equipped with a spray pump or a dispenser pump, as fragrance products to general consumers. Then, the spray pump or dispenser pump is equipped with a tube (a tube for transferring the liquid fragrance) for feeding the liquid fragrance to the spray pump or dispenser pump; and such a tube is accommodated together with the liquid fragrance in the container in the state of being immersed in the liquid fragrance. With regard to fragrance products containing the liquid fragrance, being excellent in the aesthetic property of their appearance is regarded as being suitable; hence, it is desired that the tube to be used therein is, in the state of being immersed in the liquid fragrance, low in visibility, that is, in a state of being hardly visible, particularly in a state of being substantially invisible (in a state of being viewed as being tubeless at first sight and being invisible unless cautiously viewed).

The present disclosure also relates to a tube for transferring a liquid having a refractive index of 1.35 to 1.41, and by appropriately selecting the configuration of the fluoropolymer, the tube immersed in the liquid can be made substantially invisible and the aesthetic property of the product in the state where the tube is immersed in the liquid can be made excellent.

The refractive index of the fluoropolymer is not limited, but may be 1.35 to 1.41, 1.355 or more, or 1.36 or more, and may be 1.40 or less, 1.39 or less, or 1.38 or less. The refractive index of the fluoropolymer being in this range can make the tube almost or completely invisible in the case where the tube is immersed in a liquid having a refractive index of 1.35 to 1.41, enhancing the overall aesthetic property of the product to which the assembly of the present disclosure is attached. The refractive index of the fluoropolymer can be measured at 25° C. by using an Abbe's refractometer with the sodium D-line as the light source, and can be measured by using a sheet of the fluoropolymer fabricated by the method described below.

(Method for Fabricating Sheet of Fluoropolymer)

Pellets of the fluoropolymer are charged in a metal mold of 120 mm in diameter, set on a press machine heated at 240 to 300° C., and melt pressed at a pressure of about 2.9 MPa to thereby obtain a sheet of 1.5 mm in thickness of the fluoropolymer.

The haze value of the fluoropolymer is not limited, but may be 30% or lower, 25% or lower, 22% or lower, 19% or lower, 16% or lower, or 12% or lower, and may be 0.01% or higher, 0.05% or higher, or 0.1% or higher. The haze value of the fluoropolymer being in this range allows the resulting tube to have high transparency and low visibility. Furthermore, it can make the tube almost or completely invisible in the case where the tube is immersed in a liquid having a refractive index of 1.35 to 1.41, enhancing the overall aesthetic property of the product to which the assembly of the present disclosure is attached. The haze value of the fluoropolymer can be measured for the sheet of the fluoropolymer fabricated by the above method by using a haze meter according to ASTM D1003.

The light transmittance at a wavelength of 400 nm of the fluoropolymer may be 50% or higher, 65% or higher, 73% or higher, 78% or higher, or 80% or higher, and may be 98% or lower. The light transmittance of the fluoropolymer being in this range allows the resulting tube to have high transparency and low visibility. Furthermore, it can make the tube almost or completely invisible in the case where the tube is immersed in a liquid having a refractive index of 1.35 to 1.41, enhancing the overall aesthetic property of the product to which the assembly of the present disclosure is attached. The light transmittance at a wavelength of 400 nm of the fluoropolymer can be measured for the sheet of the fluoropolymer fabricated by the above method by using a spectrophotometer at a wavelength of 400 nm.

It is preferable that the tube is insoluble in acetone. The tube being insoluble in acetone makes the tube and assembly less susceptible to degradation even when the tube and assembly are immersed in a liquid, such as liquid fragrance, for a long period of time. Accordingly, for example, even when a tube with excellent transparency is used, the transparency of the tube can be maintained for a long period of time, and even when a fragrance product is used by repeatedly refilling the container with a liquid fragrance, excellent aesthetic property in the appearance of the fragrance product is maintained for a long period of time.

The solubility in acetone can be confirmed by an immersion test of the tube in acetone, as will be described below. When the tube keeps its original shape without being dissolved by the immersion test of the tube in acetone, it can be said that the tube is insoluble in acetone.

In the present disclosure, when the tube is formed from two or more fluoropolymers, the tensile strength, refractive index, haze value, and light transmittance of the fluoropolymer described above are values measured for a mixture of the two or more fluoropolymers.

The melt flow rate (MFR) of the fluoropolymer may be 3 to 150 g/10 min, 5 g/10 min or higher, 8 g/10 min or higher, or 12 g/10 min or higher, and may be 150 g/10 min or lower, 80 g/10 min or lower, 70 g/10 min or lower, 60 g/10 min or lower, or 50 g/10 min or lower. When the melt flow rate is in this range, the generation of the melt fracture in forming into the tube can effectively be suppressed and there can thereby effectively be suppressed the increase in the visibility and the degradation of the low visibility due to the light refraction caused by irregularities by the generation of the melt fracture, resulting in that an obtained tube can be low in visibility. In particular, with the melt flow rate in the above range, even in the case where forming into the tube is carried out in a relatively high speed and also even in the case of forming into the tube small in diameter, the generation of the melt fracture can effectively be suppressed, thereby enabling contribution also to the improvement in the productivity.

The melt flow rate of the fluoropolymer can be measured according to ASTM D1238 by using a melt indexer. Set values of the measurement temperature, the load and the like may be determined by reference to the standards (for example, ASTM D2116) of individual fluoropolymers.

The content proportion of the fluoropolymer in the tube may be 90% by weight or higher, 95% by weight or higher, 98% by weight or higher, 99% by weight or higher, or 100% by weight. That is, it is most preferable that the tube is constituted substantially only of the fluoropolymer. In this case, the fluoropolymer may be one containing trace amounts of impurities and the like contained inevitably.

Examples of the fluoropolymer includes an ethylene/tetrafluoroethylene [TFE] copolymer, an ethylene/tetrafluoroethylene [TFE]/a hexafluoropropylene [HFP] copolymer, a polychlorotrifluoroethylene [PCTFE], a chlorotrifluoroethylene [CTFE]-based copolymer, a vinylidene fluoride [VdF]/tetrafluoroethylene [TFE] copolymer, a tetrafluoroethylene [TFE]/hexafluoropropylene [HFP] copolymer, and a tetrafluoroethylene [TFE]/hexafluoropropylene [HFP]/vinylidene fluoride [VdF] copolymer.

Since the visibility of the resulting tube can be made sufficiently low and the required tensile elastic modulus can be imparted to the tube, the fluoropolymer may be at least one fluoropolymer selected from the group consisting of a copolymer containing ethylene unit or HFP unit and TFE unit, and a polymer containing VdF unit, at least one fluoropolymer selected from the group consisting of a copolymer containing ethylene unit and TFE unit, and a polymer containing VdF unit, at least one selected from the group consisting of an ethylene/tetrafluoroethylene [TFE] copolymer and a VdF/TFE copolymer, or at least one selected from the group consisting of an ethylene/TFE/HFP copolymer and a TFE/HFP/VdF copolymer.

The ethylene/TFE/HFP copolymer is a copolymer containing an ethylene unit, a TFE unit and an HFP unit. It is preferable that the ethylene/TFE/HFP copolymer contains 30 to 70% by mol of the ethylene unit, 20 to 55% by mol of the TFE unit and 1 to 30% by mol of the HFP unit; it is more preferable that, 33 to 60% by mol of the ethylene unit, 25 to 52% by mol of the TFE unit and 4 to 25% by mol of the HFP unit; and it is still more preferable that, 35 to 55% by mol of the ethylene unit, 30 to 47% by mol of the TFE unit and 8 to 20% by mol of the HFP unit.

It is preferable that the ethylene/TFE/HFP copolymer further contains a monomer unit of an ethylenically unsaturated monomer (excluding ethylene, TFE and HFP). The content of the monomer unit of the ethylenically unsaturated monomer, with respect to the whole of the monomer units, may be 0.1 to 10% by mol, may be 0.1 to 5% by mol, may be 0.2 to 1% by mol, or may be 0.3 to 0.8% by mol.

The ethylenically unsaturated monomer is not limited as long as being a monomer copolymerizable with ethylene, TFE and HFP, but preferable is at least one selected from the group consisting of ethylenically unsaturated monomers (excluding ethylene, TFE and HFP) represented by the following formulas (1) and (2).

CX¹X²═CX³(CF₂)ₙX⁴ Formula (1):

wherein X¹, X², X³ and X⁴ are the same or different, and denote H, F or Cl; and n denotes an integer of 0 to 8.

CF₂═CF—ORf¹ Formula (2):

wherein Rf¹ denotes an alkyl group having 1 to 3 carbon atoms or a fluoroalkyl group having 1 to 3 carbon atoms.

As an ethylenically unsaturated monomer represented by the formula (1), preferable is at least one selected from the group consisting of CF₂═CFCl, the following formula:

CH₂═CF—(CF₂)ₙX⁴ (3)

wherein X⁴ and n are the same as in the above, and the following formula (4):

CH₂═CH—(CF₂)ₙX⁴ (4)

wherein X⁴ and n are the same as in the above; more preferable is at least one selected from the group consisting of CF₂═CFCl, CH₂═CFCF₃, CH₂═CH—C₄F₉, CH₂═CH—C₆F₁₃ and CH₂═CF—C₃F₆H; still more preferable is at least one selected from the group consisting of CF₂═CFCl, CH₂═CH—C₆F₁₃, CH₂═CFCF₃ and CH₂═CF—C₃F₆H; and especially preferable is CH₂═CF—C₃F₆H (that is, 2,3,3,4,4,5,5-heptafluoro-1-pentene (CH₂═CFCF₂CF₂CF₂H)).

As an ethylenically unsaturated monomer represented by the formula (2), preferable is at least one selected from the group consisting of CF₂═CF—OCF₃, CF₂═CF—OCF₂CF₃ and CF₂═CF—OCF₂CF₂CF₃.

The TFE/HFP/VdF copolymer is a copolymer containing TFE unit, HFP unit, and VdF unit. Since the TFE/HFP/VdF copolymer, when the VdF content is high, is excellent in flexibility and transparency, with regard to the copolymerization proportions (ratios in % by mol) of TFE/HFP/VdF, it is preferable that 25 to 75% by mol of the TFE unit, 1 to 15% by mol of the HFP unit, and 24 to 70% by mol of the VdF unit are contained; it is still more preferable that 30 to 55% by mol of the TFE unit, 3 to 14% by mol of the HFP unit, and 34 to 65% by mol of the VdF unit are contained; and it is most preferable that 30 to 40% by mol of the TFE unit, 3 to 12% by mol of the HFP unit, and 50 to 65% by mol of the VdF unit are contained. The TFE/HFP/VdF copolymer may further contain 0 to 20% by mol, 0 to 10% by mol, or 0 to 5% by mol, of another monomer unit.

The other monomer is not limited as long as it is a monomer copolymerizable with TFE, HFP, and VdF, but it may be at least one selected from the group consisting of ethylenically unsaturated monomers (excluding TFE, HFP, and VdF) represented by the following formulas (5) and (6).

CX¹¹X¹²═CX¹³(CF₂)_{q}X¹⁴ Formula (5):

wherein X¹¹, X¹², X¹³ and X¹⁴ are the same or different, and denote H, F, Cl or Br; and q denotes an integer of 0 to 8.

CF₂═CF—ORf⁴ Formula (6):

wherein Rf⁴ denotes an alkyl group having 1 to 3 carbon atoms or a fluoroalkyl group having 1 to 3 carbon atoms.

As the another monomer, preferable is at least one selected from the group consisting of ethylenically unsaturated monomers (excluding TFE, HFP and VdF) represented by the above formulas (5) and (6); more preferable is at least one selected from the group consisting of fluorine-containing monomers such as perfluoro(methyl vinyl ether), perfluoro(ethyl vinyl ether), perfluoro(propyl vinyl ether), chlorotrifluoroethylene, 2-chloropentafluoropropene and perfluorinated vinyl ethers (for example, perfluoroalkoxy vinyl ethers such as CF₃OCF₂CF₂CF₂OCF═CF₂), perfluoroalkyl vinyl ethers, perfluoro-1,3-butadiene, trifluoroethylene, hexafluoroisobutene, vinyl fluoride, ethylene, propylene and alkyl vinyl ethers; and most preferable are perfluoro(methyl vinyl ether), perfluoro(ethyl vinyl ether) and perfluoro(propyl vinyl ether).

Since the TFE/HFP/VdF copolymer, when the VdF unit content is low, is excellent in chemical resistance, with regard to the copolymerization proportions (ratios in % by mol) of the TFE unit, the HFP unit and the VdF unit, it is preferable that TFE/HFP/VdF is 45 to 95/0.1 to 15/0.1 to 45; being 45 to 85/1 to 15/5 to 45 (in molar ratio) is more preferable; being 45 to 75/2 to 15/10 to 45 (in molar ratio) is still more preferable; and being 45 to 70/5 to 15/20 to 45 (in molar ratio) is most preferable. The TFE/HFP/VdF copolymer may further contain 0 to 20% by mol, 0 to 10% by mol, or 0 to 5% by mol, of another monomer unit. As the another monomer, preferable is at least one selected from the group consisting of ethylenically unsaturated monomers (excluding TFE, HFP and VdF) represented by the above formulas (5) and (6); more preferable is at least one selected from the group consisting of fluorine-containing monomers such as perfluoro(methyl vinyl ether), perfluoro(ethyl vinyl ether), perfluoro(propyl vinyl ether), chlorotrifluoroethylene, 2-chloropentafluoropropene and perfluorinated vinyl ethers (for example, perfluoroalkoxy vinyl ethers such as CF₃OCF₂CF₂CF₂OCF═CF₂), perfluoroalkyl vinyl ethers, perfluoro-1,3-butadiene, trifluoroethylene, hexafluoroisobutene, vinyl fluoride, ethylene, propylene, CF₂═CHBr, CH₂═CH—CF₂CF₂Br, CF₂═CFBr, CH₂═CH—CF₂Br and alkyl vinyl ethers; and most preferable are perfluoro(methyl vinyl ether), perfluoro(ethyl vinyl ether) and perfluoro(propyl vinyl ether).

In the present disclosure, the content proportion of each monomer unit in the fluoropolymer can be calculated according to the types of monomer units constituting the fluoropolymer, for example, by combining NMR and elemental analysis as appropriate.

The tube may be formed from one fluoropolymer, or may be formed from two or more fluoropolymers. The two or more fluoropolymers may be two or more fluoropolymers containing different types of monomer units, may be two or more fluoropolymers containing the same types of monomer units in different content proportions, or may be two or more fluoropolymers containing the same types of monomer units in the same content proportions. By appropriately selecting the types and contents of monomer units in the fluoropolymer and the mixing ratios of fluoropolymers, for example, the refractive index, haze value, light transmittance, and tensile elastic modulus of the fluoropolymer can be adjusted within the ranges described above, and it is possible to impart insolubility in acetone to the fluoropolymer.

In particular, when two or more fluoropolymers are used, these properties can be more easily adjusted within the ranges described above by appropriately selecting the mixing ratios of the fluoropolymers without reviewing the compositional features of monomers, the raw materials for the fluoropolymers, from the polymerization stage. It is also one suitable form that the tube described above is formed from two or more fluoropolymers, for example, an ethylene/TFE/HFP copolymer and a TFE/HFP/VdF copolymer.

When the tube is formed from one fluoropolymer, the suitable fluoropolymer may be an ethylene/TFE/HFP copolymer, a VdF/TFE copolymer (a copolymer composed only of VdF unit and TFE unit), or a TFE/HFP/VdF copolymer in which the content of VdF unit is 35% by mol or lower with respect to the whole of the monomer units, since they increase the tensile elastic modulus of the fluoropolymer and enable the tube to be more easily fixed to the fitting section of the formed article.

When the tube is formed from one fluoropolymer, the more suitable fluoropolymer may be an ethylene/TFE/HFP copolymer or a TFE/HFP/VdF copolymer in which the content of VdF unit is 35% by mol or lower with respect to the whole of the monomer units, since they increase the tensile elastic modulus of the fluoropolymer and can also impart insolubility of the tube in acetone.

When the tube is formed from one fluoropolymer, the still more suitable fluoropolymer may be an ethylene/TFE/HFP copolymer (a copolymer composed only of ethylene unit, TFE unit, and HFP unit) in which the content of HFP unit is 17% by mol or higher with respect to the whole of the monomer units, or an ethylene/TFE/HFP/other monomer copolymer in which the total content of HFP unit and the other monomer unit is 12% by mol or higher with respect to the whole of the monomer units, since they increase the tensile elastic modulus of the fluoropolymer, can also easily adjust the refractive index, haze value, and light transmittance of the fluoropolymer to the ranges described above, and can further impart insolubility of the tube in acetone.

When the tube is formed from two or more fluoropolymers, the suitable combination of fluoropolymers may be any of the following:
a combination of an ethylene/TFE/HFP/ethylenically unsaturated monomer copolymer in which the content of HFP unit is 12% by mol or higher and an ethylene/TFE/HFP/ethylenically unsaturated monomer copolymer in which the content of HFP unit is less than 12% by mol;
a combination of an ethylene/TFE/HFP/ethylenically unsaturated monomer copolymer and an ethylene/TFE/HFP copolymer (a copolymer composed only of ethylene unit, TFE unit, and HFP unit);
a combination of an ethylene/TFE/HFP/ethylenically unsaturated monomer copolymer and a TFE/HFP/VdF copolymer; and
a combination of an ethylene/TFE/HFP copolymer (a copolymer composed only of ethylene unit, TFE unit, and HFP unit) and a TFE/HFP/VdF copolymer,
since they increase the tensile elastic modulus of the fluoropolymer and enable the tube to be more easily fixed to the fitting section of the formed article.

The TFE/HFP/VdF copolymer may be a copolymer composed only of TFE unit, HFP unit, and VdF unit, or may be a copolymer containing the other monomer unit described above in addition to the TFE unit, HFP unit, and VdF unit.

As for the mixing ratio of each copolymer in the combination of an ethylene/TFE/HFP copolymer and a VdF/TFE copolymer (a copolymer composed only of VdF unit and TFE unit), the mass ratio of ethylene/TFE/HFP copolymer:VdF/TFE copolymer may be 10:90 to 90:10, 30:70 to 85:15, or 45:55 to 85:15.

As for the mixing ratio of each copolymer in the combination of an ethylene/TFE/HFP copolymer (a copolymer composed only of ethylene unit, TFE unit, and HFP unit) and an ethylene/TFE/HFP/ethylenically unsaturated monomer copolymer, the mass ratio of ethylene/TFE/HFP copolymer:ethylene/TFE/HFP/ethylenically unsaturated monomer copolymer may be 10:90 to 99:1, 10:90 to 90:10, or 30:70 to 70:30.

As for the mixing ratio of each copolymer in the combination of an ethylene/TFE/HFP copolymer and a TFE/HFP/VdF copolymer, the mass ratio of ethylene/TFE/HFP copolymer:TFE/HFP/VdF copolymer may be 10:90 to 99:1, 10:90 to 90:10, 30:70 to 85:15, or 45:55 to 85:15.

When the tube is formed from two or more fluoropolymers, the more suitable combination of fluoropolymers may be any of the following:
a combination of an ethylene/TFE/HFP/ethylenically unsaturated monomer copolymer and an ethylene/TFE/HFP copolymer (a copolymer composed only of ethylene unit, TFE unit, and HFP unit);
a combination of an ethylene/TFE/HFP/ethylenically unsaturated monomer copolymer and a TFE/HFP/VdF copolymer (a copolymer composed only of TFE unit, HFP unit, and VdF unit) in which the content of VdF unit is 35% by mol or lower and the content of HFP unit is greater than 10% by mol;
a combination of an ethylene/TFE/HFP copolymer (a copolymer composed only of ethylene unit, TFE unit, and HFP unit) and a TFE/HFP/VdF copolymer (a copolymer composed only of TFE unit, HFP unit, and VdF unit) in which the content of VdF unit is 35% by mol or lower and the content of HFP unit is greater than 10% by mol;
a combination of an ethylene/TFE/HFP/ethylenically unsaturated monomer copolymer and a TFE/HFP/VdF copolymer (a copolymer composed only of TFE unit, HFP unit, and VdF unit) in which the content of VdF unit is 35% by mol or lower and the content of TFE unit is 55% by mol or higher, where the mass ratio of ethylene/TFE/HFP copolymer:TFE/HFP/VdF copolymer is 45:55 to 85:15; and
a combination of an ethylene/TFE/HFP/ethylenically unsaturated monomer copolymer and a TFE/HFP/VdF/other monomer copolymer, since they increase the tensile elastic modulus of the fluoropolymer, can also easily adjust the refractive index, haze value, and light transmittance of the fluoropolymer to the ranges described above, and can further impart insolubility of the tube in acetone.

It is particularly preferable for the tube to be formed from a copolymer containing ethylene unit, TFE unit, and HFP unit, in which the content of HFP unit may be 17% by mol or more, or 19.0% by mol or more, with respect to the whole of the monomer units, since it is extremely excellent in the balance of various properties. Furthermore, by using such a copolymer, it is possible to easily obtain a tube having the desired dimensions and shape, and it is also possible to easily obtain a tube that has a low haze value and a low yellow index, as well as a high tensile elastic modulus.

Accordingly, the present disclosure also relates to a tube for transferring a liquid having a refractive index of 1.35 to 1.41, the tube containing a copolymer containing ethylene unit, TFE unit, and HFP unit, in which the molar ratio of ethylene unit to TFE unit (ethylene unit/TFE unit) is 38.0/62.0 to 70.0/30.0 and the content of HFP unit is 1.0 to 30.0% by mol with respect to the whole of the monomer units constituting the copolymer.

The copolymer contained in the tube of the present disclosure contains ethylene unit (Et unit), TFE unit, and HFP unit.

In the copolymer contained in the tube of the present disclosure, the molar ratio (Et unit/TFE unit) may be 38.0/62.0 to 70.0/30.0, 43.0/57.0 to 65.0/35.0, 47.0/53.0 to 62.0/38.0, 51.0/49.0 to 58.0/42.0, or 52.0/48.0 to 56.0/44.0.

In the copolymer contained in the tube of the present disclosure, the content of HFP unit may be 1.0 to 30.0% by mol, 10.0 to 27.0% by mol, 15.0 to 25.0% by mol, 17.0 to 23.0% by mol, or 19.0 to 21.0% by mol, with respect to the whole of the monomer units constituting the copolymer.

It is preferable for the copolymer contained in the tube of the present disclosure to further contain a monomer unit of an ethylenically unsaturated monomer (excluding ethylene, TFE, and HFP). The content of the monomer unit of the ethylenically unsaturated monomer described above, with respect to the whole of the monomer units, may be 0.1 to 10% by mol, may be 0.1 to 5% by mol, may be 0.2 to 1% by mol, or may be 0.3 to 0.8% by mol.

The ethylenically unsaturated monomer described above is not limited as long as it is a monomer that is copolymerizable with ethylene, TFE, and HFP, but it may be at least one selected from the group consisting of ethylenically unsaturated monomers (excluding ethylene, TFE, and HFP) represented by the following formulas (1) and (2).

CX¹X²═CX³(CF₂)ₙX⁴ Formula (1):

wherein X¹, X², X³, and X⁴ are the same or different, and denote H, F, or Cl; and n denotes an integer of 0 to 8.

CF₂═CF—ORf¹ Formula (2):

wherein Rf¹ denotes an alkyl group having 1 to 3 carbon atoms or a fluoroalkyl group having 1 to 3 carbon atoms.

The ethylenically unsaturated monomer represented by the formula (1) may be at least one selected from the group consisting of CF₂═CFCl, the following formula (3):

CH₂═CF—(CF₂)ₙX⁴ (3)

wherein X⁴ and n are the same as in the above, and the following formula (4):

CH₂═CH—(CF₂)ₙX⁴ (4)

wherein X⁴ and n are the same as in the above,
at least one selected from the group consisting of CF₂═CFCl, CH₂═CFCF₃, CH₂═CH—C₄F₉, CH₂═CH—C₆F₁₃, and CH₂═CF—C₃F₆H, at least one selected from CF₂═CFCl, CH₂═CH—C₆F₁₃, CH₂═CFCF₃, and CH₂═CF—C₃F₆H, or CH₂═CF—C₃F₆H (that is, 2,3,3,4,4,5,5-heptafluoro-1-pentene (CH₂═CFCF₂CF₂CF₂H).

The ethylenically unsaturated monomer represented by the formula (2) may be at least one selected from the group consisting of CF₂═CF—OCF₃, CF₂═CF—OCF₂CF₃, and CF₂═CF—OCF₂CF₂CF₃.

The tube can be produced by forming the fluoropolymer into a tube shape. A method of forming the fluoropolymer into a tube shape is not limited, and the tube can be produced by melt extruding the fluoropolymer by using an extruding machine. Specifically, by using an extruding machine equipped with a cylinder, a screw, a die head and a die, the fluoropolymer is made into a melt state in the cylinder; the fluoropolymer in the melt state is extruded in a tube shape through the die by rotation of the screw; whereby the tube is produced.

The tube described above can be used for transferring a liquid having a refractive index of 1.35 to 1.41. When the tube described above is formed from a fluoropolymer whose tensile elastic modulus has been appropriately adjusted, it can be easily fixed to the fitting section of the formed article (the holding member of the injection apparatus) having a large tensile elastic modulus. Furthermore, when the tube is formed from a specific fluoropolymer, the tube can be made less visible, which enables it to be suitably used for transferring a liquid fragrance. The tube described above can further be suitably used as a tube for constituting a fragrance product equipped with a transparent container for accommodating a liquid containing the liquid fragrance and having a refractive index of 1.35 to 1.41 and the tube for sucking up such a liquid; and in this case, the fragrance product can be made one in which the tube is substantially invisible, and can thereby be made the one excellent in the aesthetic property of its appearance. Further in the present disclosure, a container equipped with the tube can also be provided, and such a container suitably includes containers for accommodating liquids having a refractive index of 1.35 to 1.41.

The assembly and spray container described above can be used to accommodate a liquid having a refractive index of 1.35 to 1.41 and to inject the accommodated liquid. The assembly and spray container described above can also be suitably used as a fragrance product equipped with a transparent container body for accommodating a liquid having a refractive index of 1.35 to 1.41, including a liquid fragrance, and an assembly for sucking up and injecting such a liquid. Furthermore, since the tube can be made less visible when the tube is formed from a specific fluoropolymer, the fragrance product can be made one in which the tube is substantially invisible, and can thereby be made the one excellent in the aesthetic property of its appearance.

Hitherto, one or more embodiments have been described, but it is to be understood that various changes and modifications in forms and details may be made without departing from the spirit and scope of the claims.

### Examples

Then, one or more embodiments of the present disclosure will be described by way of Examples, but the present disclosure is not any more limited only to the Examples.

Respective numerical values in Examples were measured by the following methods.

<Monomer Compositional Features of Fluoropolymer>

The monomer compositional features of the fluoropolymer were determined from the integrated value of each peak, using a nuclear magnetic resonance spectrometer AC300 (manufactured by Bruker Biospin GmbH) and performing ¹⁹F-NMR measurement at a measurement temperature of (polymer melting point+20°) C. Depending on the types of monomers, the monomer compositional features of the fluoropolymer may be determined by combining elemental analysis as appropriate.

<Melt Flow Rate (MFR)>

MFR of fluoropolymers used in Examples was determined by the following method. According to ASTM D1238 and by using a melt indexer (manufactured by Yasuda Seiki Seisakusho, Ltd.), there was determined the mass (g/10 min) of a copolymer flowing out per 10 min from its nozzle of 2.1 mm in inner diameter and 8 mm in length under a load of 5 kg. Here, the temperature in the measurement of the melt flow rate was determined as 265° C. by reference to the standard (ASTM D2116) for an individual fluoropolymer.

(Method of Fabricating a Fluoropolymer Sheet)

Pellets of a fluoropolymer were charged in a metal mold of 120 mm in diameter, set on a press machine heated at 240° C. to 300° C. and melt pressed at a pressure of about 2.9 MPa to thereby obtain a fluoropolymer sheet of 1.5 mm in thickness.

<Refractive Index>

The refractive index of fluoropolymers and a liquid fragrance used in Examples was measured at 25° C. by using an Abbe's refractometer (manufactured by Atago Co., Ltd.) with the sodium D-line as its light source. The measurement of the refractive index of a fluoropolymer was carried out by using a fluoropolymer sheet fabricated by the above method.

<Haze Value>

The haze value of fluoropolymers used in Examples was determined by the following method. Pellets of a fluoropolymer were formed into a sheet shape of 1.5 mm in thickness according to the method described above, and for the obtained sheet-shaped formed article, the haze value was measured by using a haze meter (manufactured by Toyo Seiki Seisaku-sho Ltd., Haze-Gard II) according to ASTM D1003.

<Light Transmittance at Wavelength of 400 nm>

The light transmittance at a wavelength of 400 nm of fluoropolymers used in Examples was determined by the following method. Pellets of the fluoropolymers were formed into a sheet shape of 1.5 mm in thickness according to the method described above, and the light transmittance at a wavelength of 400 nm of the obtained sheet-shaped formed article was measured by using a spectrophotometer U-4000 (manufactured by Hitachi, Ltd.).

<Tensile Elastic Modulus>

The tensile elastic modulus of fluoropolymers and polypropylene used in Examples was determined by the following method. Pellets of the fluoropolymers and polypropylene were set in a metal mold, held at 200 to 300° C. for 15 to 30 min on a heat press machine to melt the polymer, and thereafter loaded with a load of 3 MPa for 1 min to be compression molded to thereby fabricate a sheet specimen of 2 mm in thickness. Then, the obtained sheet specimen was punched out by using an ASTM D638 Type V dumbbell to thereby obtain a dumbbell specimen with a distance between marked lines of 3.18 mm. The tensile elastic modulus at 25° C. of the obtained dumbbell specimen was measured by using an Autograph (manufactured by Shimadzu Corp., AGS-J 5 kN) according to ASTM D638 under the condition of 50 mm/min.

(Fluoropolymer)

In Examples and Comparative Examples, fluororesins having the monomer compositional features and melt flow rates described in Table 1 were used as the fluoropolymer.

TABLE 1

| | Monomer compositional features (% by mol) | | | | | | MFR |
|---|---|---|---|---|---|---|---|
| Name | TFE | Et | HFP | H2P | VdF | PPVE | 265° C. |
| Fluororesin 1 | 40.8 | 44.6 | 14.0 | 0.7 | | | 33 |
| Fluororesin 2 | 47.0 | 43.0 | 9.5 | 0.5 | | | 25 |
| Fluororesin 3 | 36.0 | 44.0 | 20.0 | | | | 28 |
| Fluororesin 4 | 19.9 | | | | 80.1 | | 71 |
| Fluororesin 5 | 37.6 | | 10.9 | | 51.4 | | 21 |
| Fluororesin 6 | 68.6 | | 7.2 | | 22.9 | 1.3 | 13 |
| Fluororesin 7 | 54.2 | | 11.7 | | 34.1 | | 9 |
| Fluororesin 8 | 46.9 | | 13.3 | | 37.9 | 1.8 | 25 |
| Fluororesin 9 | 60.7 | | 8.9 | | 30.4 | | 10 |

Abbreviations in Table 1 refer to the following monomers, respectively.
Et: ethylene
TFE: tetrafluoroethylene
HFP: hexafluoropropylene
H2P: 2,3,3,4,4,5,5-heptafluoro-1-pentene (CH₂═CFCF₂CF₂CF₂H)
VdF: vinylidene fluoride
PPVE: perfluoro(propyl vinyl ether)

### Examples 1 to 17 and Comparative Examples 1 to 3

Pellets of the fluororesins shown in Table 1 were fed into the hopper of an extruding machine (cylinder shaft diameter: 20 mm, L/D=24) at the proportions shown in Table 2 and Table 3. Tubes with an outer diameter of 1.6 mm and an inner diameter of 0.8 mm were obtained by using the extruding machine to perform extrusion forming at a take-up speed of 2 m/min. The temperatures of the cylinder and die of the extruding machine were set at 160 to 300° C.

The following tests were carried out using the fabricated tubes. The results are shown in Table 2 and Table 3.

<Insertion Test of Tube into Fitting Section of Holding Member (Insertability)>

From a commercially available spray container (manufactured by Chanel SA, trade name: No 5) in which a liquid fragrance was accommodated, a dispenser assembly to which a tube was connected was removed, and the tube was then removed from the dispenser assembly. Into a fitting section (inner diameter: 1.5 mm) of a holding member (material: polypropylene, melting point: 165° C., tensile elastic modulus: 1,350 MPa) of the recovered dispenser assembly, the tubes fabricated in Examples and Comparative Examples were inserted and evaluated according to the following criteria.
∘: The tube can be inserted into the fitting section.
Δ: Sometimes the tube can be inserted into the fitting section, and sometimes the tube buckles and cannot be inserted into the fitting section.
X: The tube buckles and cannot be inserted into the fitting section.

<Immersion Test of Tube in Liquid Fragrance (Invisibility)>

The tubes fabricated in Examples and Comparative Examples were immersed in a container in which a liquid fragrance was contained (manufactured by Chanel SA, trade name: No 5, refractive index of liquid fragrance: 1.371), and photographed in the landscape mode of EOS KissX7 manufactured by Canon Inc. from a distance of 50 cm in front of the container with the background color where the RGB values are R=255, G=0, and B=0. The container captured in the obtained image was observed and evaluated according to the following criteria.
⊚: The presence of the tube can hardly be confirmed.
∘: The presence of the tube cannot be easily confirmed.
x: The presence of the tube can be easily confirmed.

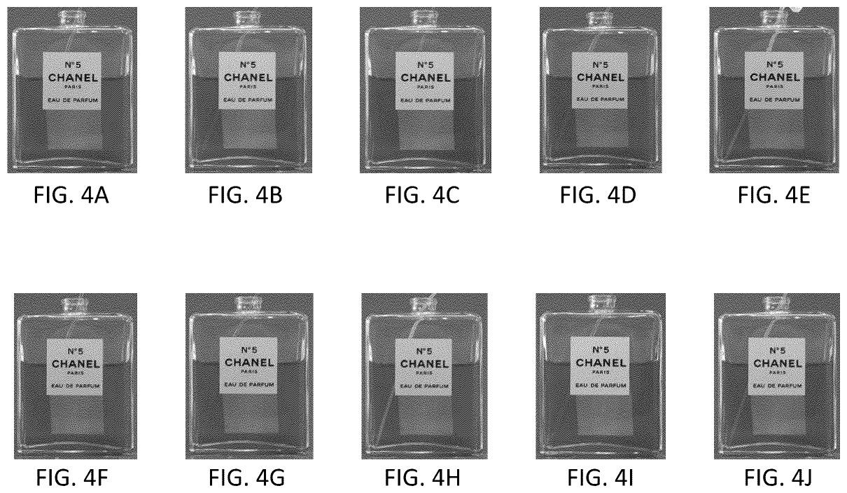

FIGS. 4A-4J are images showing the results of immersion test of tube in liquid fragrance (invisibility) of Comparative Examples 1-3 and Examples 1-7.

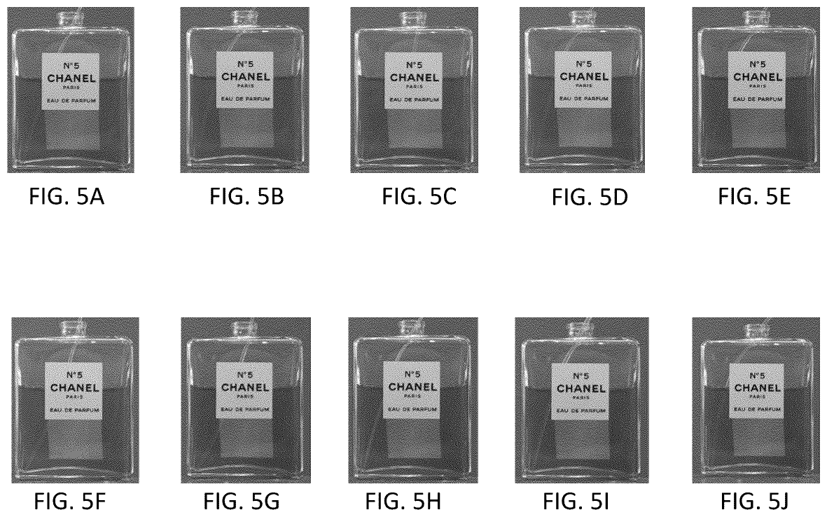

FIGS. 5A-5J are images showing the results of immersion test of tube in liquid fragrance (invisibility) of Examples 8-17.

<Immersion Test of Tube in Acetone (Insolubility)>

The tubes fabricated in Examples and Comparative Examples were immersed in acetone at room temperature for one week, and the tubes after the immersion were observed and evaluated according to the following criteria.
∘: The tube is not dissolved.
Δ: Part of the tube is dissolved.
x: The entire tube is dissolved.

A tube whose result of this test is “∘” can be said to be insoluble in acetone.

TABLE 2

| | | Compar- | Compar- | Compar- | | | | | | | |
|---|---|---|---|---|---|---|---|---|---|---|---|
| | | ative | ative | ative | | | | | | | |
| | | Example 1 | Example 2 | Example 3 | Example 1 | Example 2 | Example 3 | Example 4 | Example 5 | Example 6 | Example 7 |
| Fluororesin 1 | | | | | 100 | 50 | | 50 | | 50 | |
| Fluororesin 2 | | | | | | 50 | | | | | |
| Fluororesin 3 | | | | | | | 100 | 50 | | | |
| Fluororesin 4 | | | | | | | | | 100 | | |
| Fluororesin 5 | | 100 | | | | | | | | 50 | |
| Fluororesin 6 | | | | | | | | | | | 100 |
| Fluororesin 7 | | | 100 | | | | | | | | |
| Fluororesin 8 | | | | 100 | | | | | | | |
| Fluororesin 9 | | | | | | | | | | | |
| Refractive index | | 1.355 | 1.350 | 1.352 | 1.377 | 1.379 | 1.373 | 1.375 | 1.402 | 1.366 | 1.345 |
| Haze value (%) | | 10 | 9 | 7 | 11 | 28 | 8 | 10 | 69 | 11 | 24 |
| Transmittance (%) | | 84 | 77 | 86 | 80 | 72 | 84 | 82 | 42 | 78 | 59 |
| Tensile elastic modulus | | 51 | 246 | 43 | 652 | 726 | 320 | 486 | 696 | 351 | 410 |
| (MPa) | | | | | | | | | | | |
| Tube insertion test | | X | Δ | X | ◯ | ◯ | ◯ | ◯ | ◯ | ◯ | ◯ |
| Fragrance | Evaluation | ⊚ | ◯ | ⊚ | ◯ | X | ⊚ | ⊚ | X | ◯ | X |
| immersion test | Image | FIG. 4A | FIG. 4B | FIG. 4C | FIG. 4D | FIG. 4E | FIG. 4F | FIG. 4G | FIG. 4H | FIG. 4I | FIG. 4J |

| | | | | | | | | | | |
|---|---|---|---|---|---|---|---|---|---|---|
| Immersion test in acetone | X | ◯ | ◯ | ◯ | ◯ | ◯ | ◯ | X | Δ | ◯ |

TABLE 3

| | | Exam- | Exam- | Exam- | Exam- | Exam- | Exam- | Exam- | Exam- | Exam- | Exam- |
|---|---|---|---|---|---|---|---|---|---|---|---|
| | | ple 8 | ple 9 | ple 10 | ple 11 | ple 12 | ple 13 | ple 14 | ple 15 | ple 16 | ple 17 |
| Fluororesin 1 | | 50 | 80 | 50 | 70 | 80 | 50 | 80 | | 50 | 80 |
| Fluororesin 2 | | | | | | | | | | | |
| Fluororesin 3 | | | | | | | | | | | |
| Fluororesin 4 | | | | | | | | | | | |
| Fluororesin 5 | | | | | | | | | | | |
| Fluororesin 6 | | 50 | 20 | | | | | | | | |
| Fluororesin 7 | | | | 50 | 30 | 20 | | | | | |
| Fluororesin 8 | | | | | | | 50 | 20 | | | |
| Fluororesin 9 | | | | | | | | | 100 | 50 | 20 |
| Refractive index | | 1.361 | 1.371 | 1.364 | 1.369 | 1.372 | 1.365 | 1.372 | 1.342 | 1.360 | 1.370 |
| Haze value (%) | | 18 | 14 | 10 | 10 | 11 | 9 | 10 | 35 | 23 | 16 |
| Transmittance (e) | | 66 | 76 | 75 | 79 | 79 | 79 | 81 | 52 | 62 | 74 |
| Tensile elastic | | 531 | 603 | 449 | 530 | 570 | 347 | 530 | 380 | 516 | 597 |
| modulus (MPa) | | | | | | | | | | | |
| Tube insertion test | | ◯ | ◯ | ◯ | ◯ | ◯ | ◯ | ◯ | ◯ | ◯ | ◯ |
| Fragrance | Evalu- | ◯ | ◯ | ◯ | ◯ | ⊚ | ◯ | ◯ | X | X | ◯ |
| immersion | ation | | | | | | | | | | |
| test | Image | FIG. 5A | FIG. 5B | FIG. 5C | FIG. 5D | FIG. 5E | FIG. 5F | FIG. 5G | FIG. 5H | FIG. 5I | FIG. 5J |

| | | | | | | | | | | |
|---|---|---|---|---|---|---|---|---|---|---|
| Immersion test | ◯ | ◯ | ◯ | ◯ | ◯ | ◯ | ◯ | ◯ | ◯ | ◯ |
| in acetone | | | | | | | | | | |

### REFERENCE SIGNS LIST

10 Spray container
11 Container body
12 Liquid
20 Injection apparatus
21 Injection button
22 Injection port
23 Holding member (formed article)
24 Fitting section
25 Inner circumferential surface of fitting section
30 Tube
31 Outer circumferential surface of tube
32 Cut-out

Although the disclosure has been described with respect to only a limited number of embodiments, those skilled in the art, having benefit of this disclosure, will appreciate that various other embodiments may be devised without departing from the scope of the present disclosure. Accordingly, the scope of the invention should be limited only by the attached claims.

1. An assembly comprising:
a tube that transfers a liquid having a refractive index of 1.35 to 1.41; and
a formed article provided with a fitting section to which one end of the tube is fitted,
wherein:
the formed article is formed from a non-fluoropolymer, and the tube is formed from a fluoropolymer having a tensile elastic modulus of 300 MPa or more, and
the non-fluoropolymer has a tensile elastic modulus that is not less than 1.2 times the tensile elastic modulus of the fluoropolymer.

2. The assembly according to claim 1, further comprising an injection apparatus that injects the liquid having a refractive index of 1.35 to 1.41,
wherein the injection apparatus comprises the formed article as a holding member provided with the fitting section to which one end of the tube is fitted.

3. The assembly according to claim 1, wherein the fluoropolymer has a refractive index of 1.35 to 1.41.

4. The assembly according to claim 1, wherein the fluoropolymer has a haze value of 30% or lower.

5. The assembly according to claim 1, wherein the fluoropolymer has a light transmittance at a wavelength of 400 nm of 50% or higher.

6. The assembly according to claim 1, wherein the tube is formed from at least one fluoropolymer selected from the group consisting of a copolymer containing ethylene unit and tetrafluoroethylene unit, and a polymer containing vinylidene fluoride unit.

7. The assembly according to claim 1, wherein the tube is formed from two or more fluoropolymers having different monomer compositional features.

8. The assembly according to claim 1, wherein the tube is insoluble in acetone.

9. The assembly according to claim 1, wherein the formed article is formed from at least one non-fluoropolymer selected from the group consisting of a polyolefin and a polyester.

10. The assembly according to claim 1, wherein an inner circumferential surface of the fitting section of the formed article is provided with unevenness.

11. The assembly according to claim 1, wherein an inner diameter of the fitting section of the formed article is smaller than an outer diameter of the tube by 0.5% or more.

12. The assembly according to claim 1, wherein a cut-out is provided at at least the one end of the tube.

13. A fragrance product comprising:
the assembly according to claim 1; and
a container body.
